(19) United States
(12) Patent Application Publication
(10) Pub. No.: US 2002/0107734 A1
(43) Pub. Date: Aug. 8, 2002

(54) Personal information application system

(75) Inventor: Atsushi Fukumoto, Toyota (JP)

Correspondence Address: MCDERMOTT, WILL & EMERY, 600 13th Street, N.W., WASHINGTON, DC, 20005-3096, US

(73) Assignee: MITSUBISHI DENKI KABUSHIKI KAISHA

(21) Appl. No.: 09/921,565

(22) Filed: Aug. 6, 2001

(30) Foreign Application Priority Data
Feb. 6, 2001 (JP) P2001-029356

(51) Int. Cl. G06F 17/60

(52) U.S. Cl. 705/14

(57) ABSTRACT

A consumer supplies personal information such as his/her name and merchandise to be purchased, recorded in his/her personal information terminal, to an information processing part of a store or a corporation such as a maker or a service provider through a connection interface provided on the store front or a network. The consumer receives advertisement related to merchandise and/or service responsive to his/her demand from the corporation, so that the personal information is effectively applied to business and industry. Thus, a personal information application system is so provided that each consumer can readily obtain advertisement of merchandise and/or service responsive to his/her demand and a corporation can readily obtain information about needs and trends of purchase of consumers.

### BACKGROUND OF THE INVENTION

1. Field of the Invention

The present invention relates to a personal information application system capable of effectively applying personal information related to each consumer such as his/her name, his/her address, his/her contact address, his/her interest/liking, merchandise and/or service to be purchased by him/her and the like to business and industry.

2. Description of the Background Art

At present, a general consumer refers to advertisement through a medium such as a paper medium, television or radio, advertisement on a homepage on the Internet, advertisement through an electronic mail or the like to purchase merchandise and/or service.

Further, the consumer supplies personal information such as his/her name, his/her address, his/her mail address, his/her interest/liking, merchandise to be purchased by him/her and the like in response to a questionnaire or the like through a postcard, by telephone, over the counter or on the Internet in exchange for a gift or the like.

On the other hand, a store or each corporation such as a maker or a service provider (this term stands for an enterprise such as a financial institution providing service as merchandise) publicizes new merchandise and/or new service or sends information about merchandise and/or service on sale through the aforementioned advertisement.

Further, the corporation collects questionnaires for recognizing the needs and trends of purchase of consumers and developing new merchandise and/or new service. The corporation builds a database related to customer information on the basis of the contents of the questionnaires for its business activities in order to find new customers or the like.

However, a general consumer does not necessarily visits a store with reference to advertisement of the corporation. For example, it is rather difficult for a consumer accidentally dropping in a store or a branch of a corporation for the first time to recognize information about merchandise and/or service handled therein in detail if no leaflets, for example, are obtainable. While the consumer can of course ask a salesclerk about the merchandise and/or service, the salesclerk does not necessarily have a thorough knowledge of all merchandise and/or service, and the quantity of verbally information is limited.

Even if the consumer can collect leaflets, the leaflets are so readily scattered and lost that he/she cannot trace all information about the prices and the variety of merchandise handled in the store or the branch of the enterprise to be compared with merchandise and/or service handled in other stores later, for example. In other words, it is difficult to keep and put advertisement information in order.

The aforementioned advertisement is generally directed to unspecified consumers. In practice, however, the contents of merchandise and/or service desired by individual consumers are so multifarious that the advertisement directed to unspecified consumers is not necessarily useful for the individual consumers.

In order to retrieve desired merchandise from advertisement on the Internet, the consumer must search through homepages or electronic mails for items to be comparatively checked such as the prices and functions of merchandise and/or service provided by respective corporations, service contents and the like. In the case of the advertisement on the Internet, however, the forms and display contents of the homepages or the electronic mails generally vary with corporations. Therefore, it is troublesome for the consumer to search for the items to be comparatively checked through the homepages or the electronic mails.

Further, it is also troublesome for the consumer to fill out the aforementioned questionnaires of various corporations with the same contents such as his/her name, his/her address and the like. Therefore, the questionnaires are not satisfactorily collected.

On the other hand, the store or the corporation such as a maker or a service provider cannot satisfactorily collect questionnaires unless free gifts or the like in exchange therefor are remarkably excellent. Thus, the effect of such questionnaires is not necessarily satisfactory in consideration of a great deal of labor and cost (the cost for printing the questionnaires, the labor for inputting responses in the database and the like).

It is generally difficult to obtain information about merchandise and/or service desired by individual consumers from such insufficient responses to the questionnaires. Even if such information is obtained, it costs a great deal to prepare individual advertisement for each consumer (e.g. a direct mail having contents arranged in response to demands of each consumer) and hence the corporation is forced to make advertisement for unspecified consumers.

### SUMMARY OF THE INVENTION

A personal information application system according to a first aspect of the present invention comprises a personal information terminal recording personal information related to a consumer who is its owner as electronic data and an information processing part, having a connection interface capable of connecting the personal information terminal thereto without through a network, recording advertisement information related to merchandise and/or service as electronic data, while the information processing part reads the personal information and the personal information terminal reads the advertisement information when the personal information terminal is connected to the information processing part through the connection interface.

According to the first aspect, the information processing part reads the personal information and the personal information terminal reads the advertisement information when the personal information terminal is connected to the information processing part, whereby the consumer can obtain the advertisement information in exchange for the personal information when visiting a store or a branch of a corporation such a maker or a service provider having the information processing part with the personal information terminal. Also when visiting the store or the branch absolutely for the first time, therefore, the consumer can obtain information of merchandise and/or service handled therein, so that each consumer can readily obtain advertisement of desired merchandise and/or service. Further, the advertisement information is electronic data, which is hardly scattered and lost but can be readily kept and put in order dissimilarly to leaflets. On the other hand, the store or the corporation such as a maker or a service provider having the information processing part can obtain the personal information of each visiting consumer for recognizing the needs and trends of purchase of consumers. In this case, neither questionnaires for investigating the needs and trends of purchase of consumers may be printed nor the contents of responses thereto may be input in a database, whereby information about the needs and trends of purchase of consumers can be obtained at a low cost.

According to a second aspect of the present invention, the personal information includes information related to merchandise and/or service desired by the consumer, and the advertisement information includes advertisement information related to merchandise and/or service desired by the consumer selected on the basis of previously read personal information.

According to the second aspect, the advertisement information includes the advertisement information related to the merchandise and/or the service desired by the consumer, whereby the consumer can readily obtain advertisement of the desired merchandise/service and the advertisement can consequently more effectively arouse the consumer's interest. Further, advertisement information suitable for each consumer can be transmitted to the consumer, so that the store or the corporation such as a maker or a service provider having the information processing part can more effectively make advertisement as compared with the case of dealing with unspecified customers.

According to a third aspect of the present invention, the information processing part further has a display part for displaying advertisement information related to the merchandise and/or service desired by the consumer when the personal information terminal is electrically connected to the information processing part through the connection interface.

According to the third aspect, the display part displays the advertisement information related to the merchandise and/or the service desired by the consumer, whereby the consumer's interest on the merchandise and/or the service can be more effectively aroused.

According to a fourth aspect of the present invention, the personal information terminal and the information processing part have an electronic settlement function, and the electronic settlement function is executable when the personal information terminal is connected to the information processing part through the connection interface.

According to the fourth aspect, the personal information terminal and the information processing part have the electronic settlement function, whereby the consumer can readily settle accounts with a corporation having the information processing part.

A personal information application system according to a fifth aspect of the present invention comprises a personal information terminal recording personal information related to a consumer who is its owner as electronic data and a plurality of information processing parts, connectable with the personal information terminal through or without through a network, recording advertisement information related to merchandise and/or service as electronic data, while one of the information processing parts reads the personal information and the personal information terminal reads the advertisement information when the personal information terminal is connected to one of the information processing parts, and the personal information is electronic data recorded in a common format readable by all of the plurality of information processing parts.

According to the fifth aspect, the consumer can obtain the advertisement information in exchange for the personal information when connecting the personal information terminal to an information processing part set on the store or the branch of the corporation such as a maker or a service provider. Further, the advertisement information is electronic data, which is hardly scattered and lost but can be readily kept and put in order dissimilarly to leaflets. In addition, the personal information is electronic data recorded in the common format readable by all of the plurality of information processing parts. Once the consumer inputs the personal information in the personal information terminal, therefore, the personal information to be supplied to the information processing part of any corporation may not be newly input every corporation. Therefore, the consumer can readily supply the personal information to the corporation, which in turn can readily obtain information about the needs and trends of purchase of consumers. In this case, the corporation may neither print questionnaires for investigating the needs and trends of purchase of consumers nor input the contents of responses thereto in a database, whereby information about the needs and trends of purchase of consumers can be obtained at a low cost.

According to a sixth aspect of the present invention, every advertisement information from the plurality of information processing parts is displayed in a common display form in the personal information terminal. According to the sixth aspect, every advertisement information is displayed on the personal information terminal in a common display form, whereby the consumer can readily comparatively check items such as the prices and functions of the merchandise and/or the service of respective corporations, service contents and the like.

According to a seventh aspect of the present invention, the personal information terminal and the plurality of information processing parts have an electronic settlement function, and the electronic settlement function is executable when the personal information terminal is connected to the information processing part.

According to the seventh aspect, the personal information terminal and the plurality of information processing parts have the electronic settlement function, whereby the consumer can readily settle accounts with corporations having the plurality of information processing parts respectively.

A personal information application system according to an eighth aspect of the present invention comprises a plurality of personal information terminals recording personal information related to consumers who are owners thereof as electronic data, a plurality of first information processing parts recording advertisement information related to merchandise and/or service as electronic data and a second information processing part connectable with the personal information terminals and the first information processing parts through or without through a network for reading the personal information and the advertisement information from the personal information terminals and the first information processing parts and recording the same, while the personal information includes information related to merchandise and/or service desired by the consumers, and the second information processing part transmits consumer information related to general trends of consumers created on the basis of the personal information to the first information processing parts while transmitting advertisement information related to the merchandise and/or service desired by the consumers selected from the advertisement information on the basis of previously read personal information to the personal information terminals.

According to the eighth aspect, the second information processing part transmits the advertisement information related to the merchandise and/or the service desired by the consumer selected from the advertisement information on the basis of previously read personal information, whereby the consumer can readily obtain advertisement of desired merchandise and/or service The second information processing part selects the advertisement information from the plurality of first information processing parts, whereby the consumer can readily comparatively check the prices and functions of the merchandise and/or the service, service contents and the like provided by respective corporations having the first information processing parts. Further, the advertisement information is electronic data, which is hardly scattered and lost but can be readily kept and put in order dissimilarly to leaflets. In addition, the personal information recorded in the second information processing part serves as the backup for the personal information recorded in the personal information terminal. The second information processing part transmits consumer information created on the basis of the personal information to the first information processing parts, whereby a store or a corporation such as a maker or a service provider having any of the first information processing parts can obtain consumer information related to general trends of consumers for recognizing the needs and trends of purchase of consumers. In this case, the corporation having the first information part may neither print questionnaires for investigating the needs and trends of purchase of consumers nor input the contents of responses thereto in a database, whereby information about the needs and trends of purchase of consumers can be obtained at a low cost. The owner of the second information processing part, transmitting the advertisement information from the corporation having any of the first information processing parts to the consumer, can obtain advertising revenue from the corporation having the first information processing part. Further, the owner of the second information processing part, transmitting consumer information related to general trends of consumers created on the basis of the personal information to the first information processing parts, can obtain the market research fee from corporations having the first information processing parts.

According to a ninth aspect of the present invention, the first information processing parts are capable of reading the personal information recorded in the second information processing part.

According to the ninth aspect, the first information processing parts can read the personal information recorded in the second information part, whereby corporations having the first information processing parts can find new customers with reference to the personal information.

According to a tenth aspect of the present invention, the personal information terminals and the first information processing parts are connectable with each other through or without through a network, the personal information terminals and the first information processing parts have an electronic settlement function, and the electronic settlement function is executable when the personal information terminals are connected to the first information processing parts.

According to the tenth aspect, the personal information terminals and the first information processing parts have the electronic settlement function, whereby the consumers can readily settle accounts with corporations having the first information processing parts.

Accordingly, an object of the present invention is to provide a personal information application system enabling each consumer to readily obtain advertisement of desired merchandise and/or service while enabling a corporation to readily obtain information on the needs and trends of purchase of consumers.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a personal information application system according to an embodiment of the present invention;

FIGS. 2 to 5 illustrate exemplary personal information of a consumer;

FIG. 6 illustrates a personal information terminal PT of the consumer connected to a connection interface IF for a register RG of a store;

FIG. 7 illustrates exemplary advertisement information transmitted from the store;

FIG. 8 illustrates the personal information terminal PT of the consumer connected to a connection interface IF2 for an advertisement information display DP2 of the store; and

FIG. 9 illustrates an exemplary advertisement information display screen of the advertisement information display DP2.

### DESCRIPTION OF THE PREFERRED EMBODIMENTS

An embodiment of the present invention is directed to a personal information application system through which a consumer can supply personal information recorded in his/her personal information terminal (a personal computer or a portable information terminal such as a PDA (personal digital assistant) or a portable telephone) as electronic data to an information processing part of a store or a corporation such as a maker or a service provider through a connection interface provided on the store or through a network while receiving advertisement information responsive to desired merchandise and/or service from the corporation so that the personal information can be effectively applied to business and industry.

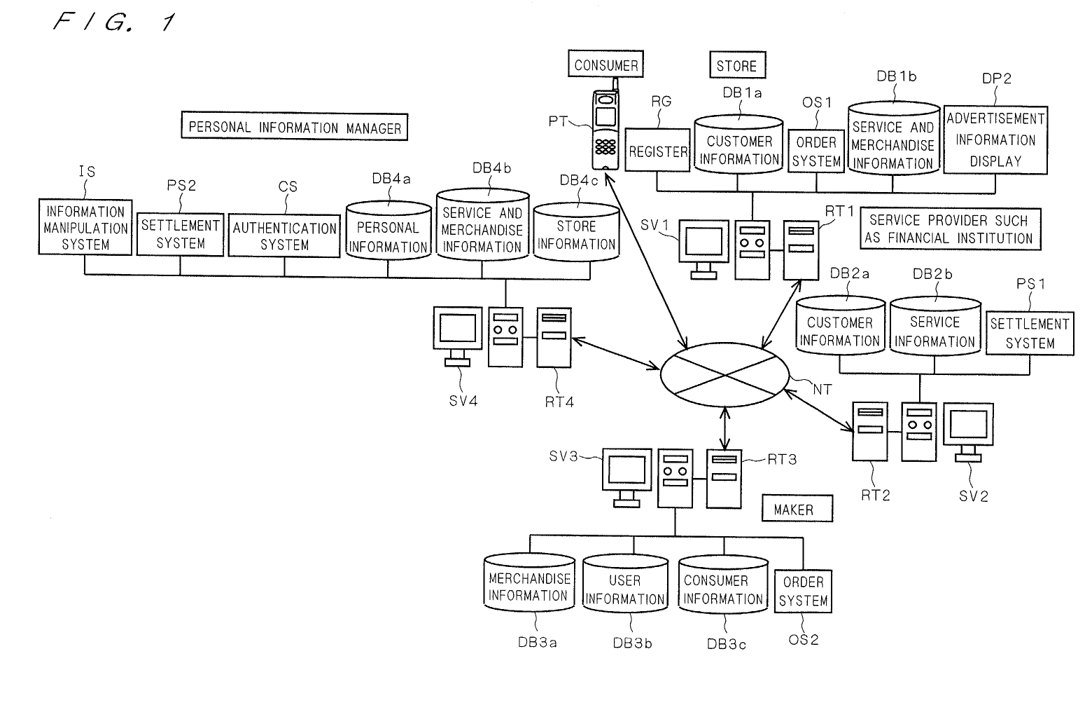

FIG. 1 illustrates the personal information application system according to this embodiment. A consumer purchasing merchandise and/or service, a store selling merchandise and/or service, a service provider such as a financial institution providing service, a maker manufacturing merchandise and a personal information manager managing personal information of the consumer appear in FIG. 1. The personal information manager is an undertaker managing the personal information of the consumer, advertising merchandise and/or service of the maker, the service provider and the store, and settling accounts similarly to a financial institution. The personal information manager is described later in detail.

The consumer possesses a personal information terminal PT previously recording his/her personal information such as his/her name, his/her address, his/her mail address, his/her interest/liking, merchandise and/or service to be purchased by him/her and the like as electronic data. This personal information terminal PT has an electronic settlement flnction such as the function of a credit card or a cash card or the function of electronic money.

The store possesses an information processing part including a router RT1 taking charge of path selection on a network NT, a server SV1 controlling transmission/receiving of information on the network NT, a register RG managing transmission/receiving of money following trade of merchandise and/or service, an order system OS1 taking charge of receiving/placing orders of merchandise and/or service, a customer information database DB1a recording information related to customers as electronic data, an advertisement information display DP2 for displaying advertisement information and a service and merchandise information database DB1b recording information about merchandise and/or service from the maker and the service provider as electronic data. All of the router RT1, the register RG, the order system OS1, the customer information database DB1a, the advertisement information display DP2 and the service and merchandise information display DB1b are connected to the server SV1.

The service provider possesses an information processing part including a router RT2 taking charge of path selection on the network NT, a server SV2 controlling transmission/receiving of information on the network NT, a customer information database DB2a recording information related to customers as electronic data, a service information database DB2b recording information about handled service as electronic data and a settlement system PS1 taking charge of financial settlement. All of the router RT2, the settlement system PS1, the customer information database DB2a and the service information database DB2b are connected to the server SV2.

The maker possesses an information processing part including a router RT3 taking charge of path selection on the network NT, a server SV3 controlling transmission/receiving of information on the network NT, a merchandise information database DB3a recording handled merchandise as electronic data, a user information database DB3b recording information related to users of its merchandise as electronic data, a consumer information database DB3c recording consumer information related to general trends of consumers such as the needs and trends of purchase of the consumers as electronic data and an order system OS2 taking charge of receiving/placing orders of merchandise. All of the router RT3, the order system OS2, the merchandise information database DB3a, the user information database DB3b and the consumer information database DB3c are connected to the server SV3.

The personal information manager possesses an information processing part including a router RT4 taking charge of path selection on the network NT, a server SV4 controlling transmission/receiving of information on the network NT, an information manipulation system IS manipulating various information, a settlement system PS2 taking charge of financial settlement, an authentication system CS performing authentication when taking charge of financial settlement, a personal information database DB4a recording personal information of the consumer as electronic data, a service and merchandise information database DB4b recording information about merchandise and service handled by the maker and the service provider as electronic data and a store information database DB4c recording information of merchandise and/or service handled by the store as electronic data. The router RT4, the information manipulation system IS, the settlement system PS2, the authentication system CS, the personal information database DB4a, the service and merchandise information database DB4b and the store information database DB4c are connected to the server SV4.

All routers RT1 to RT4 are connected to the network NT such as the Internet.

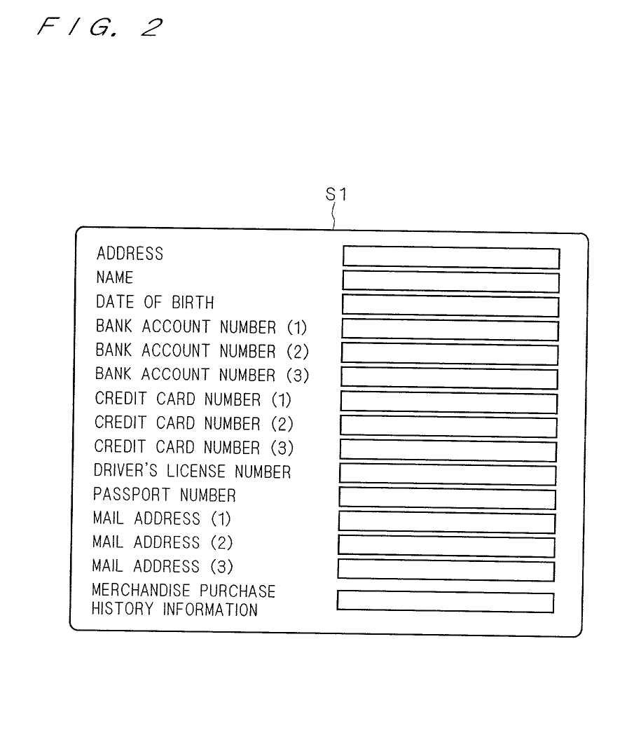

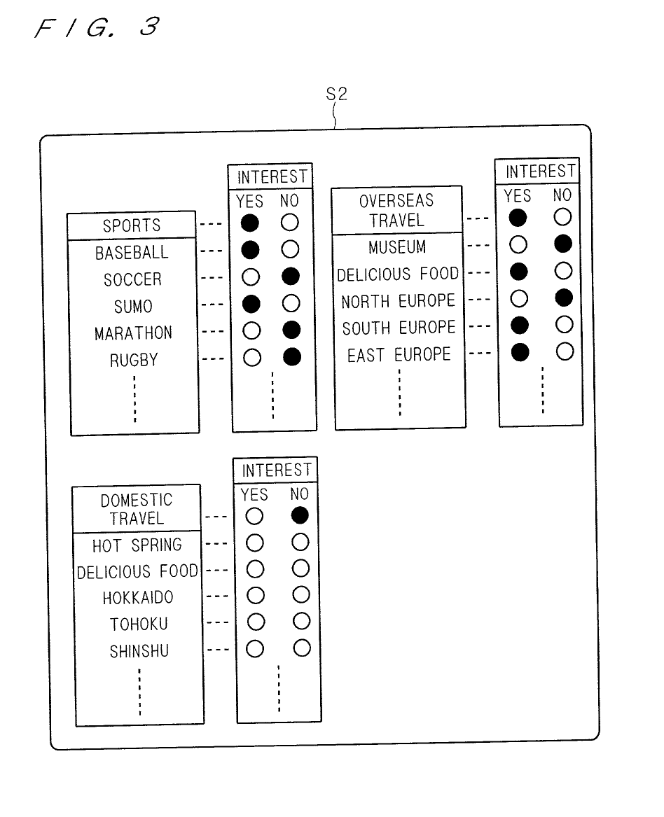

FIGS. 2 to 5 illustrate concrete examples of the personal information of the consumer. First, the address, the name, the date of birth, bank account numbers, credit card numbers, the driving license number, the passport number and mail addresses of the consumer can be exemplified, as shown in FIG. 2. These data are employed for authentication of the consumer or the like. The personal information may further include information about merchandise and/or service purchased by the customer in the past as merchandise purchase history information.

FIG. 3 shows information related to interest/liking of the consumer also included in the personal information. Referring to FIG. 3, the consumer expresses whether or not he/she is interested in various fields related to sports, overseas travel and the like by selecting check boxes, for example.

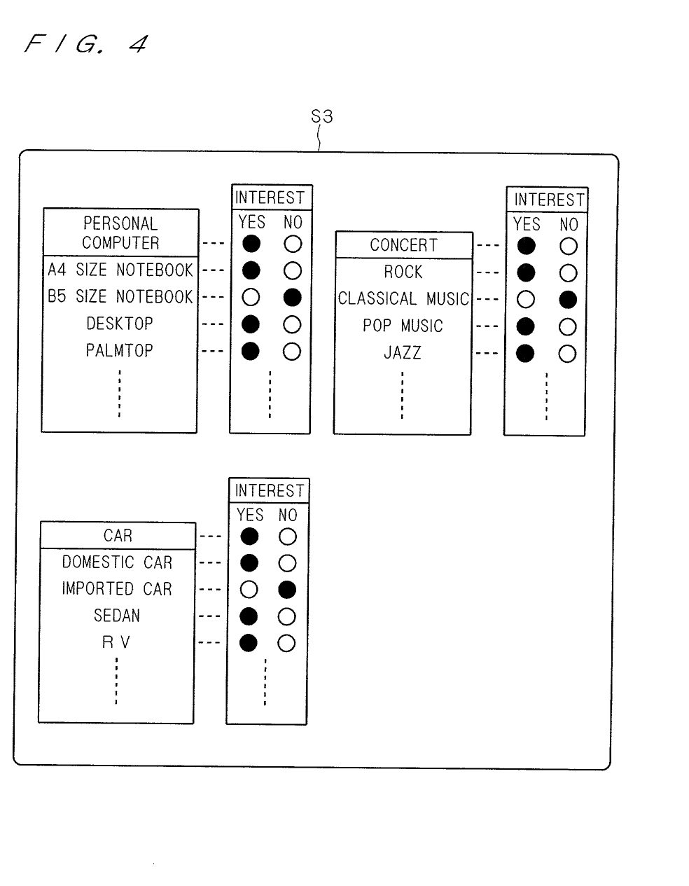

FIG. 4 shows information related to merchandise and/or service interesting the consumer planning to purchase the same also included in the personal information.

Referring to FIG. 4, the consumer expresses whether or not he/she is interested in various fields of merchandise such as a personal computer, a concert etc. and service by selecting check boxes, for example.

FIG. 5 shows requests as to merchandise and/service desired by the consumer described in an arbitrary text input form also included in the personal information.

Such personal information is recorded in the personal information terminal PT as electronic data and further supplied to the store, the maker, the service provider and the personal information manager under a constant condition, to be effectively applied to business and industry. This is now described.

It is assumed that the aforementioned personal information is recorded in a common format readable by any of the information processing parts of the store, the maker, the service provider and the personal information manager. The consumer may be enabled to freely download this format from the server SV1 of the store, for example, through the network NT.

The merchandise and/or service interesting the user changes with time, and hence the consumer updates the contents of the personal information recorded in the personal information terminal PT when the contents of the personal information have changed.

A. Relation Between Consumer and Store

a1. When the Consumer Visits the Store in Practice:

The flow of the personal information and the advertisement information taking place when the consumer shown in FIG. 1 visits the store having the information processing part with the personal information terminal PT in practice (without through the network NT).

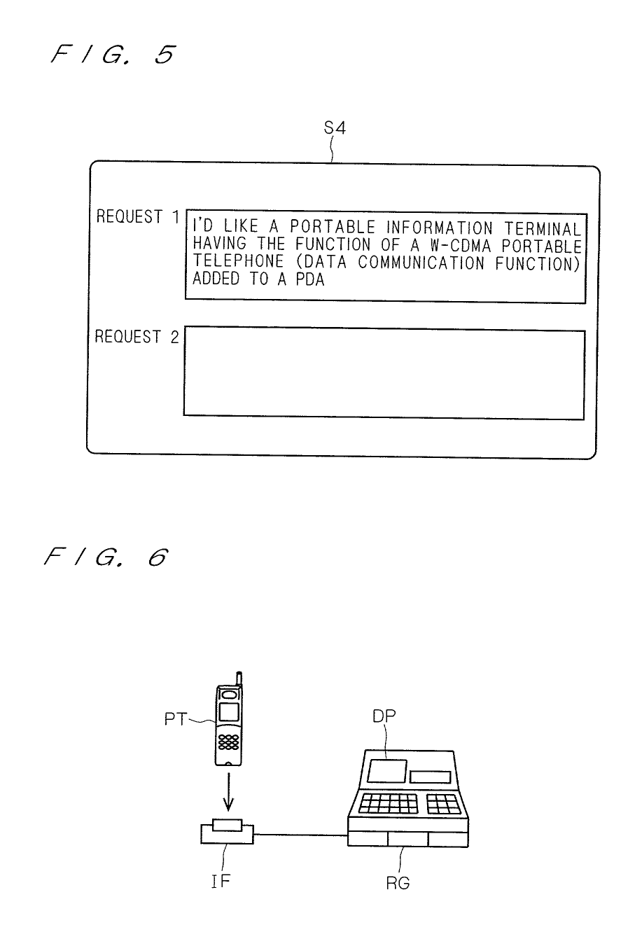

It is assumed that the register RG of the store has a slot-type connection interface IF electrically connectable with the personal information terminal PT as shown in FIG. 6, for example. It is also assumed that the register RG also has an electronic settlement function.

First, the consumer utilizes the electronic settlement function of the personal information terminal PT for purchasing merchandise and/or service at the store. The consumer can readily settle accounts with the electronic settlement function. At this time, the consumer connects the personal information terminal PT to the connection interface IF of the register RG for settling accounts for the purchased merchandise and/or service between the personal information terminal PT and the register RG.

When the personal information terminal PT is connected to the register RG through the connection interface IF, the register RG reads the personal information recorded in the personal information terminal PT. Then, the register RG records the read personal information in the customer information database DB1a. In the personal information, the information about the credit card numbers and the bank account numbers is utilized for electronic settlement while the information about the passport number and the driver's license number is utilized for authentication.

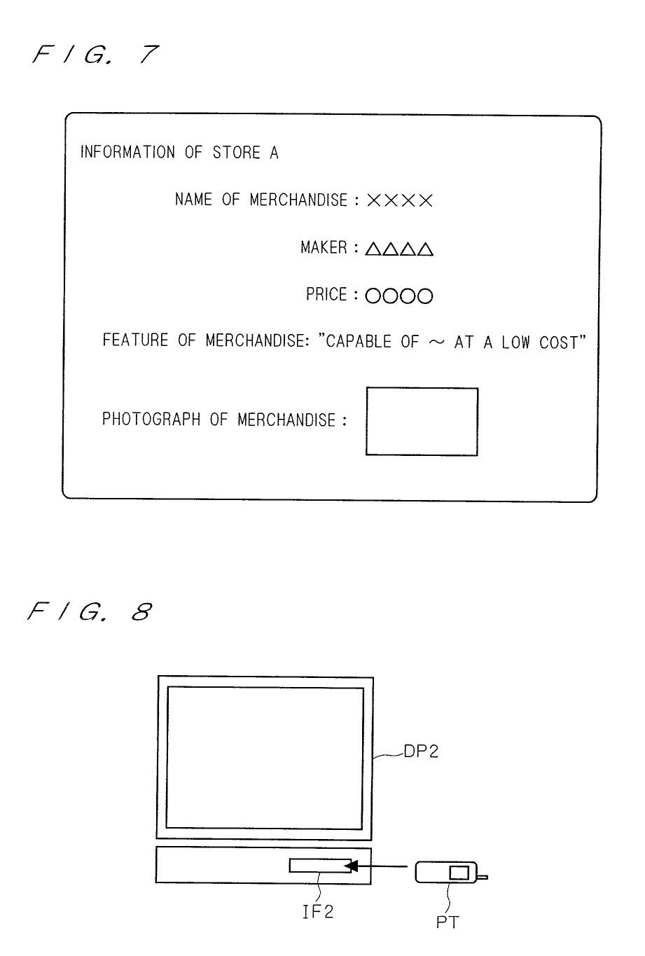

On the other hand, the register RG makes the personal information terminal PT read the information about merchandise and/or service recorded in the service and merchandise information database DB1b as advertisement information. FIG. 7 shows exemplary advertisement information. Referring to FIG. 7, the name of merchandise, the name of the maker, the price, the feature of the merchandise and a photograph of the merchandise are described as exemplary advertisement for the merchandise.

When the consumer expects the register RG not to read the personal information, the personal information terminal PT may be rendered so settable that the personal information cannot be read therefrom in order to protect the customer's privacy, as a matter of course. More concretely, the personal information may be rendered encryptable, for example. This is the aforementioned constant condition.

When the register RG reads the personal information and the personal information terminal PT reads the advertisement information upon connection of the personal information terminal PT to the register RG as described above, the consumer visiting the store with the personal information terminal PT can obtain the advertisement information in exchange for the personal information. Therefore, also when visiting the store for the first time, for example, the consumer can obtain information about merchandise and/or service handled by the store so that he/she can readily obtain advertisement of desired merchandise and/or service. Further, the advertisement information obtained from the store is electronic data, which is hardly scattered and lost but can be readily kept and put in order dissimilarly to leaflets.

On the other hand, the store can obtain the personal information of the visiting consumer and recognize the needs and trends of consumers therefrom. On the basis of the information, the store can adjust the amount of order for sellable merchandise and read variation of the trends of purchase with the changing seasons for applying the information to administration. In this case, the information about the needs and trends of consumers can be obtained at a low cost since neither cost for printing questionnaires for investigating the needs and trends of consumers nor labor for inputting the contents of the responses thereto in the database is required.

Thus, the personal information can be effectively applied to business and industry with the personal information application system according to this embodiment. The connection interface IF, exemplarily illustrated as a slot type one in FIG. 6, may alternatively be electrically connected with the personal information terminal PT in a wireless manner through the Bluetooth technique, for example.

The store cannot predict merchandise and/or service interesting the consumer visiting the same for the first time since the personal information of this consumer is yet unknown to the store. Therefore, the store may arbitrarily select the advertisement information by picking up merchandise most selling this month, for example.

On the other hand, personal information of a consumer having visited the store has already been read and hence the store may select advertisement information for this consumer on the basis of his/her read personal information. More concretely, the register RG may transmit advertisement information of personal computers for a consumer interested in “PERSONAL COMPUTER” in FIG. 4, for example.

The register RG may select the advertisement information. When the personal information is recorded in the check box system as shown in FIGS. 3 and 4, advertisement information of the corresponding merchandise can be readily captured from the service and merchandise information database DB1b.

As to selection of the advertisement information, the store may predict the period when commodities previously purchased by the consumer are out of stock and transmit advertisement information facilitating additional purchase or advertisement information pointing out that the consumer may have forgotten purchasing commodities on the basis of merchandise purchase history information included in the personal information or transmit advertisement information of merchandise and/or service meeting the customer's liking on the basis of interest/liking information included in the personal information.

When the advertisement information transmitted from the register RG includes advertisement related to merchandise and/or service desired by the consumer in the aforementioned manner, the consumer can readily obtain advertisement of desired merchandise and/or service. Consequently, the advertisement can more effectively arouse the customer's desire to purchase merchandise and/or service. Further, it follows that the store can transmit advertisement information suitable for each consumer, to be capable of more effectively making advertisement as compared with the case of dealing with unspecified consumers.

The register RG may be provided with a display DP for displaying advertisement, as shown in FIG. 6. In this case, the store can more effectively facilitate the consumer to purchase merchandise and/or service.

If the aforementioned personal information is recorded in a common format readable by a plurality of stores, the consumer may input the personal information in the personal information terminal PT only once so that the personal information may not be newly input every store. Thus, the consumer can readily supply the personal information to each store, which in turn can readily obtain information about the needs and trends of the consumer.

On the other hand, advertisement information transmitted from each store may also be displayed in a common format in the personal information terminal PT. In other words, every advertisement information from each store is displayed in a display format shown in FIG. 7, for example. In this case, the consumer can readily comparatively check items such as the prices and functions of the merchandise and/or service handled by the stores, the contents of service and the like.

The personal information terminal PT may be electrically connected to the advertisement information display DP2 provided with a connection interface IF2 similar to the connection interface IF, as shown in FIG. 8. In this case, the personal information read through the connection interface IF2 is recorded in the customer information database DB1a, while the personal information terminal PT reads the information of the merchandise and/or service recorded in the service and merchandise information database DB1b as advertisement information and the advertisement information display DP2 simultaneously displays the information on its screen.

Thus, the store can present advertisement information suitable to each consumer for facilitating him/her to purchase merchandise and/or service even if the consumer does not connect the personal information terminal PT to the register RG (i.e., also to a consumer visiting the store for just looking around without purchasing merchandise and/or service).

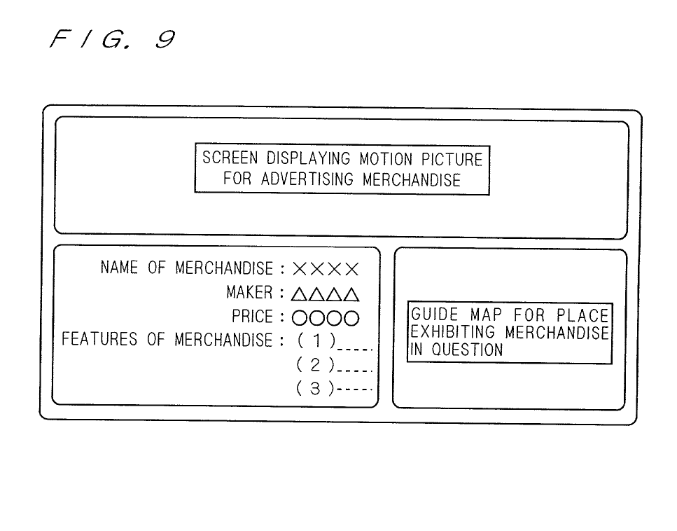

FIG. 9 shows an exemplary advertisement information display screen of the advertisement information display DP2. Referring to FIG. 9, exemplary advertisement for merchandise is formed by the name of the merchandise, the name of the maker, the price and features of the merchandise as well as a screen displaying a motion picture for advertising the merchandise and a guide map for the place exhibiting the merchandise in question in the store.

a2. When the Consumer Accesses the Store Through the Network:

While the consumer visits the store having the information processing part with the personal information terminal PT in practice in the above description, an effect similar to the above can be attained also in net trading through the network NT. In this case, the order system OS1 serves as the aforementioned register RG, for transmitting/receiving personal information and advertisement information between the same and the personal information terminal PT.

B. Relation Between Consumer and Service Provider or Maker

Also when the consumer purchases service handled by the service provider such as a financial institution, the personal information and advertisement information may be transmitted/received between the personal information terminal PT and the information processing part of the service provider. In this case, the settlement system PS1 of the service provider may have a function similar to that of the register RG in the case of the above item al. or that of the order system OS1 in the case of the above idem a2. Thus, the settlement system PS1 records the personal information in the customer information database DB2a and transmits advertisement information of its service from the service information database DB2b to the personal information terminal PT, so that an effect similar to the above can be attained.

The consumer may directly purchase merchandise from the maker. Also in this case, the personal information and advertisement information may be transmitted between the personal information terminal PT and the information processing part of the maker, similarly to the case of the above item A. In this case, the order system OS2 of the maker may have a function similar to that of the register RG in the case of the above item a1. or that of the order system OS1 in the case of the above item a2. Thus, the order system OS2 records the personal information in the user information database DB3b and transmits advertisement information of the merchandise of the maker from the merchandise information database DB3a to the personal information terminal PT, so that an effect similar to the above can be attained.

C. Relation Between Store and Service Provider or Maker

The store gathers numerous personal information as described in the above item A. Therefore, the store can effectively apply the numerous personal information to business and industry.

In other words, the store analyzes the personal information recorded in the customer information database DB1a and performs statistic processing etc. for creating consumer information related to general trends of consumers such as prediction of selling merchandise, variation of trends of purchase with the changing seasons and trends of needs of users. The store provides the consumer information to the maker and the service provider for payment. The order system OS1 may include a computer having an excellent statistic processing function, in order to create the consumer information.

Further, the store records advertisement information of merchandise and service transmitted from the maker and the service provider through the network NT in the service and merchandise information database DB1b. Then, the store transmits the advertisement information to each consumer transmitting the personal information.

At this time, the store selects the advertisement information in response to the interest/liking and requests of each consumer on the basis of previously read personal information and transmits the advertisement information suitable for each consumer to the personal information terminal PT through the connection interface IF or the network NT.

The store transmits the consumer information created on the basis of the personal information to the maker and the service provider, which in turn can obtain the consumer information related to the general trends of consumers and recognize needs and trends of the consumers from the consumer information. In this case, the maker and the service provider can obtain the information about the needs and trends of the consumers at a low cost with no requirement for a cost for printing questionnaires for investigating the needs and trends of consumers or labor for inputting the contents of responses thereto in any database. Further, the store transmits the advertisement information suitable for each consumer to the personal information terminal PT, whereby it follows that the maker and the service provider can more effectively make advertisement as compared with the case of dealing with unspecified consumers.

On the other hand, the store transmitting the advertisement information from the maker and the service provider to the consumer can obtain the charges therefor from the maker or the service provider as advertisement fees. Further, the store transmitting the consumer information related to the general trends of consumers created on the basis of the personal information to the maker and the service provider can obtain the charges therefor as market research fees.

D. Relation Between Consumer and Personal Information Manager

The personal information manager is now described. As hereinabove described, the personal information manager is an undertaker managing the personal information of the consumer, advertising merchandise and/or service of the maker and the service provider as well as information of the store and settling accounts similarly to a financial institution.

The personal information manager manages the personal information by archiving the personal information recorded in the personal information terminal PT as a backup file in case of loss of the information. The owner of the personal information terminal PT transmits his/her personal information to the information processing part of the personal information manager through the network NT, and the personal information manager records the received personal information in the personal information database DB4a.

The personal information related to the privacy of the consumer must be carefully managed so that the same is not altered or stolen. Therefore, the authentication system CS makes authentication when the personal information is transmitted/received.

When the contents of the personal information recorded in the personal information terminal PT are updated, the personal information terminal PT may retransmit the updated personal information to the personal information manager automatically or in response to the owner's intention.

The personal information manager advertises merchandise and/or service and information of the store in the following manner: The personal information manager records advertisement information of merchandise and/or service transmitted from the maker and the service provider through the network NT and advertisement information of the store transmitted from the store through the network NT in the service and merchandise information database DB4b and the store information database DB4c respectively. Then, the personal information manager transmits the advertisement information to each consumer transmitting the personal information.

At this time, the personal information manager selects the advertisement information in response to interest/liking and requests of each consumer on the basis of previously read personal information and transmits the advertisement information suitable for each consumer to the personal information terminal PT through the network NT.

The personal information manager settles accounts similarly to a financial institution by attending business similarly to a financial institution such as a bank. When the consumer previously enters into a contract for setting up a bank account with the personal information manager and purchases merchandise and/or service from the store, the service provider or the like, electronic settlement is made between the bank account of the consumer and that of the store, the service provider or the like.

While a corporation attending such business is not yet found under the present circumstances, the following advantages can be attained when the same can be implemented:

When the personal information manager selects advertisement information related to merchandise/service desired by the consumer on the basis of the recorded personal information and transmits the selected advertisement information to the personal information terminal PT, the consumer can readily obtain advertisement of desired merchandise and/or service.

The personal information manager selects the advertisement information from multiple advertisement information, whereby the consumer can readily comparatively check items such as the prices, functions, service contents and the like of the merchandise and/or service provided by the store, the maker and the service provider. Further, the advertisement information is electronic data, which is hardly scattered and lost but can be readily kept and put in order dissimilarly to leaflets.

While the information processing part of the personal information manager and the personal information terminal PT of the consumer are connected with each other through the network NT in the above, the personal information terminal PT may alternatively be rendered directly connectable with the server SV4, for example, through an interface such as the connection interface IF or the former may be electrically connected with the latter in a wireless manner through the Bluetooth technique, for example.

This also applies to the information processing part of the personal information manager and the information processing parts of the store, the maker and the service provider, which may be connected either through or without through the network NT. The information processing parts are connected without through the network NT when the information processing part of the store is formed by a portable notebook-sized personal computer, for example, a person in charge of the store visits the personal information manager with the notebook-sized personal computer and directly connects the personal computer to the information processing part of the personal information manager through an interface such as the connection interface IF or electrically connects the former to the latter in a wireless manner through the Bluetooth technique or the like.

E. Relation Between Personal Information Manager and Store, Maker and Service Provider

The personal information manager gathers numerous personal information, as described in the above item D. Therefore, the personal information manager can effectively apply the numerous personal information to business and industry.

In other words, the personal information manager analyzes the numerous personal information and performs statistic processing etc. for creating consumer information related to general trends of consumers such as prediction of selling merchandise, variation of trends of purchase with the changing seasons and trends of needs of users. The personal information manager provides the consumer information to the store, the maker and the service provider for payment.

The information manipulation system IS including a computer excellent in statistic processing or the like may create the consumer information. The store, the maker and the service provider may record the received consumer information in the databases thereof. Referring to FIG. 1, the maker records the consumer information in the consumer information database DB3c, for example.

The personal information manager transmits the consumer information created on the basis of the personal information to the store, the maker and the service provider, which in turn can obtain the consumer information related to the general trends of consumers and recognize needs and trends of consumers from the consumer information. In this case, the store, the maker and the service provider can obtain the information about the needs and trends of consumers at a low cost with no requirement for a cost for printing questionnaires for investigating the needs and trends of consumers or labor for inputting the contents of responses thereto in any database. Further, the personal information manager transmits the advertisement information suitable for each consumer to the personal information terminal PT, whereby it follows that the store, the maker and the service provider can more effectively make advertisement as compared with the case of dealing with unspecified consumers.

On the other hand, the personal information manager transmitting the advertisement information from the store, the maker and the service provider to the consumer can get the charges therefor from the store, the maker and the service provider as advertisement fees. Further, the personal information manager transmitting the consumer information related to the general trends of consumers created on the basis of the personal information to the store, the maker and the service provider can get the charges therefor as market research fees.

Further, the store, the maker and the service provider may be enabled to read the personal information recorded in the personal information database DB4a of the personal information manager for payment. Thus, the store, the maker and the service provider can find new customers with reference to the personal information.

While the invention has been shown and described in detail, the foregoing description is in all aspects illustrative and not restrictive. It is therefore understood that numerous modifications and variations can be devised without departing from the scope of the invention.

What is claimed is:

1. A personal information application system comprising:
a personal information terminal recording personal information related to a consumer being its owner as electronic data; and
an information processing part, having a connection interface capable of connecting said personal information terminal thereto without through a network, recording advertisement information related to merchandise and/or service as electronic data, wherein
said information processing part reads said personal information and said personal information terminal reads said advertisement information when said personal information terminal is connected to said information processing part through said connection interface.

2. The personal information application system according to claim 1, wherein
said personal information includes information related to merchandise and/or service desired by said consumer, and
said advertisement information includes advertisement information related to merchandise and/or service desired by said consumer selected on the basis of previously read said personal information.

3. The personal information application system according to claim 2, wherein
said information processing part further has a display part for displaying advertisement information related to said merchandise and/or service desired by said consumer when said personal information terminal is electrically connected to said information processing part through said connection interface.

4. The personal information application system according to claim 1, wherein
said personal information terminal and said information processing part have an electronic settlement function, and
said electronic settlement function is executable when said personal information terminal is connected to said information processing part through said connection interface.

5. A personal information application system comprising:
a personal information terminal recording personal information related to a consumer being its owner as electronic data; and
a plurality of information processing parts, connectable with said personal information terminal through or without through a network, recording advertisement information related to merchandise and/or service as electronic data, wherein
one of said information processing parts reads said personal information and said personal information terminal reads said advertisement information when said personal information terminal is connected to said one of said information processing parts, and
said personal information is electronic data recorded in a common format readable by all said plurality of information processing parts.

6. The personal information application system according to claim 5, wherein
every said advertisement information from said plurality of information processing parts is displayed in a common display form in said personal information terminal.

7. The personal information application system according to claim 5, wherein
said personal information terminal and said plurality of information processing parts have an electronic settlement function, and
said electronic settlement function is executable when said personal information terminal is connected to said information processing part.

8. A personal information application system comprising:
a plurality of personal information terminals recording personal information related to consumers being owners thereof as electronic data;
a plurality of first information processing parts recording advertisement information related to merchandise and/or service as electronic data; and
a second information processing part connectable with said personal information terminals and said first information processing parts through or without through a network for reading said personal information and said advertisement information from said personal information terminals and said first information processing parts and recording the same, wherein
said personal information includes information related to merchandise and/or service desired by said consumers, and
said second information processing part transmits consumer information related to general trends of consumers created on the basis of said personal information to said first information processing parts,
while transmitting advertisement information related to said merchandise and/or service desired by said consumers selected from said advertisement information on the basis of previously read said personal information to said personal information terminals.

9. The personal information application system according to claim 8, wherein
said first information processing parts are capable of reading said personal information recorded in said second information processing part.

10. The personal information application system according to claim 8, wherein
said personal information terminals and said first information processing parts are connectable with each other through or without through a network,
said personal information terminals and said first information processing parts have an electronic settlement function, and
said electronic settlement function is executable when said personal information terminals are connected to said first information processing parts.
